(19) United States
(12) Patent Application Publication
(10) Pub. No.: US 2026/0063520 A1
(43) Pub. Date: Mar. 5, 2026

(54) Removal of Surrounding Cells From a Biological Sample Using Piezo-Actuation

(71) Applicant: Conceivable Life Sciences Inc., New York, NY (US)

(72) Inventors: Gerardo Mendizabal-Ruiz, Guadalajara (MX); Nuno Costa-Borges, Barcelona (ES); Alejandro Chavez Badiola, Mexico City (MX); Jacques Cohen, New York, NY (US)

(21) Appl. No.: 19/312,746

(22) Filed: Aug. 28, 2025

Related U.S. Application Data
(60) Provisional application No. 63/688,299, filed on Aug. 28, 2024.

(51) Int. Cl. G01N 1/40; B01L 3/02

(52) U.S. Cl. CPC G01N 1/4077; B01L 3/0227; B01L 3/0237; B01L 2400/0406

(57) ABSTRACT

A system for removal of surrounding cells from a biological sample includes a pipette including a proximal section and a distal section with an opening configured to contact the biological sample. A suction channel, ending at the opening, is defined through the proximal and distal sections. A suction source is fluidly coupled with the pipette. The suction source is configured to create a negative pressure within the suction channel. A piezo actuator is mechanically coupled with the pipette. The piezo actuator is configured to drive piezo vibration of the pipette to remove ones of the surrounding cells.

### CROSS-REFERENCE TO RELATED APPLICATIONS

This application claims the benefit of U.S. Provisional Application No. 63/688,299 filed Aug. 28, 2024, the entire disclosure of which is incorporated by reference.

### FIELD

The present disclosure relates to fertility treatment automation and preparation and more particularly to preparation of biological samples for use in fertility treatments.

### BACKGROUND

Oocytes recovered from mature ovarian follicles during in vitro fertilization (IVF) are surrounded by nursing cells, such as cumulus cells. These cells, along with the oocytes, are referred to as the cumulus-oocyte complex (COC). In standard IVF procedures, COCs are inseminated with multiple sperm. Spermatozoa must traverse the corona radiata and penetrate the zona pellucida of the oocyte to reach the ovum proper. This is achieved by releasing hydrolytic enzymes from the acrosome, a sac located at the sperm cell's tip. The enzymes, notably hyaluronidase and acrosin-a trypsin-like protease that digests the zona pellucida-facilitate this process alongside sperm motility. In traditional IVF procedures, artificial breakdown of the COC is unnecessary, as the multitude of spermatozoa secretes sufficient hydrolytic enzyme to remove the cumulus mass while loosening corona cells. However, IVF now constitutes only a small fraction of assisted reproduction treatments.

Higher fertilization rates are associated with intracytoplasmic sperm injection (ICSI), which involves injecting a single sperm cell directly into the oocyte's cytoplasm. This mechanical procedure is complex and challenging to master. The initial step traditionally requires artificial removal of cumulus cells using hyaluronidase, derived from either natural sources or recombinant products. While hyaluronidase can disperse the cumulus cell matrix within minutes, the corona radiata cells adjacent to the zona pellucida are more resistant to removal. Traditionally, these cells are mechanically removed using fine-bore capillary microtools coupled with a hand-held aspirator, with the finest bore being narrower than the oocyte diameter. Although effective when performed by experienced practitioners, the narrow-bore pipette may inadvertently damage the zona pellucida and the oocyte, with an estimated damage rate of 5-15%. Despite explorations into alternatives like ultrasound, the mechanical method (also referred to as stripping), remains the standard.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

This section provides a general summary of the disclosure, and is not a comprehensive disclosure of its full scope or all of its features.

One aspect of the disclosure provides a system for removal of surrounding cells from a biological sample. The system includes a pipette including a proximal section and a distal section with an opening configured to contact the biological sample. A suction channel, ending at the opening, is defined through the proximal and distal sections. A suction source is fluidly coupled with the pipette. The suction source is configured to create a negative pressure within the suction channel. A piezo actuator is mechanically coupled with the pipette. The piezo actuator is configured to drive piezo vibration of the pipette to remove ones of the surrounding cells.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a schematic visual representation of a traditional process for removal of surrounding cells from a biological sample.

FIG. 2 is a schematic view of a system for use in the removal of surrounding cells from a biological sample, the system including a pipette holder, a pipette, and a piezo actuator, according to the principles of the present disclosure.

FIG. 3 is a perspective view of the pipette of FIG. 2 in use in the removal of the surrounding cells from the biological sample, according to the principles of the present disclosure.

FIG. 4 is a perspective view of the pipette of FIG. 2 in use in the removal of the surrounding cells from the biological sample, according to the principles of the present disclosure.

FIG. 5 is a perspective view of the pipette of FIG. 2 in use in the removal of the surrounding cells from the biological sample, according to the principles of the present disclosure.

FIG. 6A-6D are schematic plan views of various stages in the process of the removal of the surrounding cells from the biological sample by the pipette of FIG. 2, according to the principles of the present disclosure.

In the drawings, reference numbers may be reused to identify similar and/or identical elements.

### DETAILED DESCRIPTION

### Introduction

The present disclosure presents a novel technology demonstrating remarkable efficiency and speed with preparation of COCs, such as mammalian COCs, where the mammal may be a human, mouse, etc. It uses a piezo-actuated device firmly attached to the aspirator pipette. The method begins with cumulus cell removal, which may be performed using hyaluronidase and a large-bore pipette, followed by corona radiata cell removal via piezo-actuation. This is achieved by positioning the piezo pipette against the corona radiata cells while the oocyte may be kept steady using a larger holding pipette. In various implementations, when a second pipette is used, the two tools are employed in opposition. The process may be executed on a micromanipulator setup, with a holding or wide-bore pipette stabilizing the oocyte and a small-bore pipette for piezo actuation. The oocyte may roll but can be maintained near the piezo pipette with the larger bore holding pipette. The corona cells will drop off using the piezo-mediated pipette. This pipette is controlled to avoid contacting the zona pellucida of the oocyte. While the piezo-mediated pipette may be held perpendicularly on the zona pellucida, head-on contact with the zona pellucida may be avoided. In various other implementations, the piezo-mediated pipette is positioned parallel to the zona pellucida. Touching the zona pellucida with a parallel pipette is less likely to cause injury to the oocyte cytoplasm and zona pellucida. The oocyte should be held in front of the pipette tip rather than within it. Completion time for the procedure ranges from 1 to 2 minutes and can be performed manually with a micromanipulator or automated through computer vision and robotic piezo control.

In over 130 mouse COCs treated with this procedure, the damage rate to the oocyte was observed to be less than 5%. Immunofluorescence analysis of the meiotic spindle in a subset of mouse oocytes (n=13) denuded with the piezo procedure showed a normal barrel shape morphology in all oocytes analyzed with the chromosomes correctly aligned in the metaphase plate. In the remaining mouse oocytes that were inseminated by ICSI, blastocyst formation (61.2%) and total cell counts (average 158.3±28.95) were comparable to those of mouse COCs treated with hyaluronidase and standard mechanical stripping used as controls (68.6% and 147.8±35.5). Additionally, 49 blastocysts produced from mouse oocytes denuded with the piezo approach were transferred into synchronized recipients resulting in 80% pregnancy rates (4/5). Those females that resulted pregnant, delivered 15 live pups, corresponding to a 38.5% live birth rates that was comparable to that obtained in the control group (42.5%). Notably, the concentration of hyaluronidase required for our method can be reduced (for example, by half), thereby decreasing the risk of hydrolytic overexposure. The piezo-mediated denudation procedure was also tested on 8 bovine and 14 rabbit COCs with complete removal of corona cells and no damage to the oocyte proper.

In various implementations, this method is cost-effective and rapid. In various implementations, it may reduce exposure to hydrolytic enzyme and requires no specialized microtools or instruments beyond those already present in standard IVF laboratories. In various implementations, it yields a higher recovery rate than conventional mechanical techniques, offering significant improvements in oocyte handling during IVF procedures.

### Preparation of COCs for ICSI

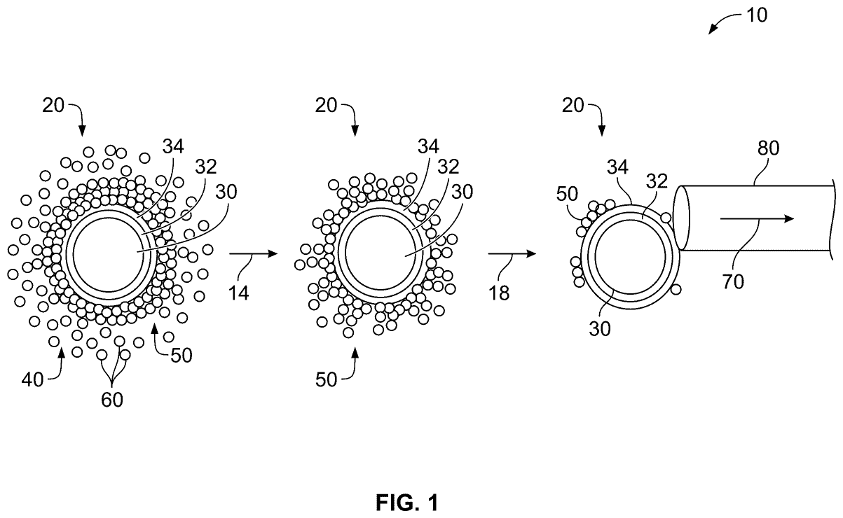

FIG. 1 illustrates a schematic visual representation of a traditional process 10 for preparation of a biological sample, illustrated herein as a COC 20, for an ICSI procedure. The COC 20 includes an oocyte 30 that includes a zona pellucida 34 that is spaced from the oocyte 30 about a perivitelline space 32. A cloud of surrounding cells, illustrated herein as a cloud or a set of cumulus cells 40 surround the oocyte 30 and the zona pellucida 34. The set of cumulus cells 40 includes a subset of corona cells 50, that may be more densely and closely clustered about the oocyte 30 and the zona pellucida 34, and a subset of non-corona cumulus cells 60, that are positioned about the subset of corona cells 50 and may be less tightly concentrated than the subset of corona cells 50.

In a first step 14 of the COC 20 preparation process 10, at least some of the subset of non-corona cumulus cells 60 are removed from the COC 20. As described previously, in traditional COC 20 preparation processes 10, the removal of the subset of non-corona cumulus cells 60 may be accomplished by the application of hyaluronidase to the COC 20 until at least some of the subset of non-corona cumulus cells 60 have been detached or removed from the COC 20. In one example, the hyaluronidase exposure may continue until all of the non-corona cumulus cells 60 have been removed or detached from the COC 20, leaving only the subset of corona cells 50 carried with the oocyte 30. The detached or removed non-corona cumulus cells 60 may remain in the culture medium surrounding the COC 20, or may be removed from the culture medium surrounding the COC 20, such as by suction pipetting.

With the non-corona cumulus cells 60 removed from the COC 20, and the corona cells 50 remaining with the oocyte 30, a second step 18 of the COC 20 preparation process 10 includes the removal of at least some of the subset of corona cells 50 from the oocyte 30. The removal of the corona cells 50 from the oocyte 30 is traditionally accomplished mechanically by application of a negative pressure or suction 70 by a pipette 80, such as by repeatedly drawing the COC 20 up into the pipette 80 to force mechanical shedding of the subset of corona cells 50 from the oocyte 30. In one example, the removal of the corona cells 50 may include repeatedly drawing the COC 20 up into pipettes (not shown) of increasingly smaller diameters until removal of the corona cells 50 is accomplished. However, the removal of the corona cells 50 by the suction 70 alone can be harsh on the oocyte 30, requiring repeated and vigorous aspiration of the COC 20 by the suction 70 to be taken up and removed from the COC 20 into the pipette 80.

In one example, the second step 18 may proceed until all of the corona cells 50 have been removed from the oocyte 30 to expose the entirety of the zona pellucida 34. In another example, the second step 18 may proceed until at least some of the corona cells 50 have been removed from the oocyte 30, such as until at least a portion of the zona pellucida 34 is exposed. Specifically, the removal of the corona cells 50 may proceed until the portion of the zona pellucida 34 that is exposed is sufficiently large that the zona pellucida 34 can be contacted by a pipette, which may be the pipette 80 or may be a separate holding pipette, such as for pickup or movement of the oocyte 30.

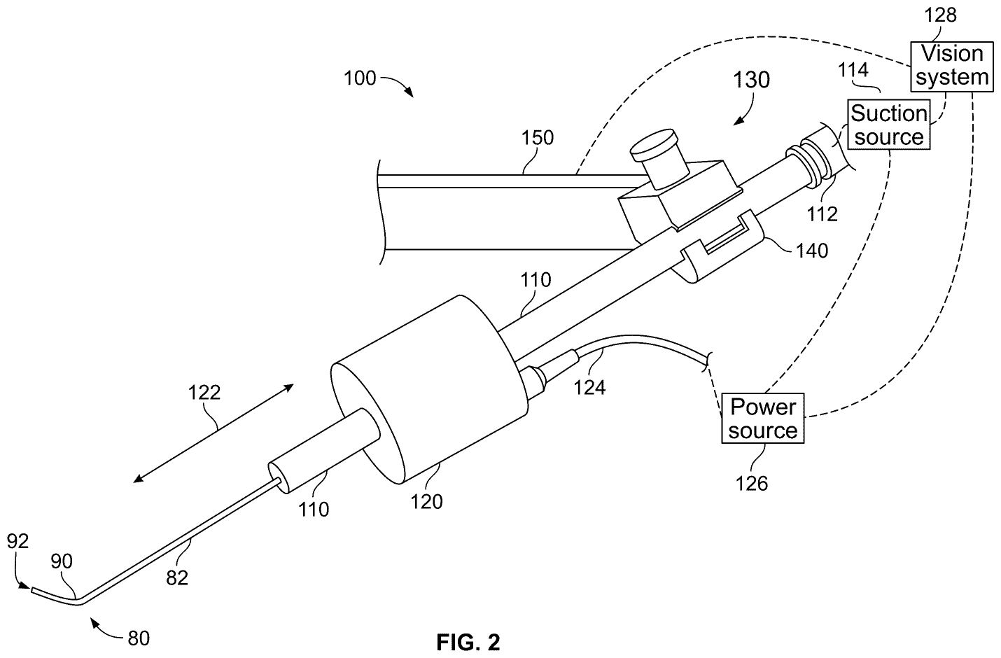

FIG. 2 illustrates a schematic view of an alternative system 100 for the removal of the cumulus cells 40 from the COC 20. The pipette 80 for use within the system 100 may include a first or proximal section 82 and a second or distal section 90 with an opening 92 configured to contact at least a portion of the COC 20. As illustrated, the distal section 90 may be positioned at a non-zero angle with respect to the proximal section 82. The non-zero angle of the distal section 90 relative to the proximal section 82 may be any suitable non-zero angle. In one example, the distal section 90 may be provided at substantially 90 degrees relative to the proximal section 82. In another example, the distal section 90 may be provided at just under 180 degrees relative to the proximal section 82, for ease of manufacturing of the pipette 80. However, it is also contemplated that the proximal section 82 and the distal section 90 may be collinear with respect to one another to form a single-piece, unitary pipette 80.

The system 100 includes a pipette holder 110 that is configured to carry the pipette 80, specifically the proximal section 82. The pipette holder 110 is further coupled to a suction conduit 112 that is, in turn, coupled to a suction source 114. Thus, the pipette holder 110 fluidly couples the suction conduit 112 and the suction source 114 with the pipette 80 to provide the negative pressure or suction 70 to the pipette 80, specifically to the opening 92. In this way, the suction source 114 is configured to create the negative pressure or suction 70 within the pipette 80.

A piezo actuator 120 is carried by and mechanically coupled with the pipette holder 110. A power cord 124 electrically couples the piezo actuator 120 with a power source 126. When the power source 126 energizes the piezo actuator 120, the piezo actuator 120 is configured to drive piezo vibration of the pipette holder 110, in a direction 122 indicated by an arrow, which may be parallel to the pipette holder 110. In turn, when the pipette holder 110 carries the pipette 80, the pipette holder 110 therefore also mechanically couples the piezo actuator 120 with the pipette 80 to drive piezo vibration of the pipette 80 to aid in the removal of the cumulus cells 40 from the COC 20.

As the piezo actuator 120 drives piezo vibration of the pipette holder 110 in the direction 122 parallel to the pipette holder 110, and the proximal section 82 of the pipette 80 is collinear with the pipette holder 110, the piezo vibration driven by the piezo actuator 120 in the direction 122 is also parallel with the proximal section 82 of the pipette 80. Thus, in the example that the proximal section 82 and the distal section 90 of the pipette 80 are collinear, the piezo vibration driven by the piezo actuator 120 in the direction 122 is also parallel with the distal section 90 of the pipette 80. However, in the example that the distal section 90 is provided at a non-zero angle with respect to the proximal section 82, the piezo vibration driven by the piezo actuator 120 in the direction 122 would drive piezo vibration of the distal section 90 in a direction that is non-parallel, or at a non-zero angle, relative to the distal section 90.

The system 100 includes a pipette positioning system 130 that is configured to position the pipette holder 110, and therefore also the pipette 80, with respect to the COC 20. The pipette positioning system 130 includes a clamp portion 140 that carries the pipette holder 110. The clamp portion 140 is coupled to and carried by an arm 150, which may be a robotic pipetting arm 150 that is configured to robotically manipulate the pipette holder 110 and the pipette 80. The clamp portion 140 may include a dampening feature configured to prevent piezo vibration from being transmitted from the pipette holder 110 to the clamp portion 140 and/or the robotic pipetting arm 150.

The system 100 may also include a vision system 128 configured to image the operation of the system and the progress of removal of the cumulus cells 40 from the COC 20. The suction source 114, the power source 126 of the piezo actuator 120, and the pipette positioning system 130 may all be operably coupled with the vision system 128, such that the vision system 128 may affect the operation of at least one of the suction source 114, the power source 126, and the pipette positioning system 130.

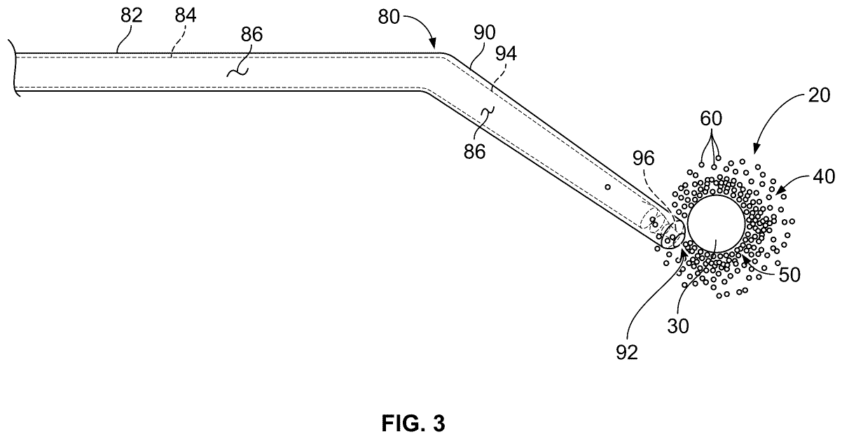

FIG. 3 illustrates the structure of the pipette 80 in greater detail. A suction channel 86 is defined through the proximal section 82 and the distal section 90, ending at the opening 92, such that the negative pressure or suction 70 created within the pipette 80 is created within the suction channel 86. Specifically, the proximal section 82 includes a bore 84 and the distal section 90 includes a bore 94, with the suction channel 86 extending through the bores 84, 94 and ending at the opening 92. The distal section 90 may include a lumen portion 90 that narrows the diameter of the suction channel 86 from the bore 94 of the distal section 90 to the opening 92, such that a diameter of the bore 94 is larger than a diameter of the opening 92. In one example, the pipette 80 may be a glass capillary pipette, such as a large-bore pipette, though it will be understood that any suitable material and type of pipette may be used. The edges of the opening 92 may be rounded, such as by sanding or polishing, to ensure that no sharp edges may contact the COC 20 during the removal of the cumulus cells 40.

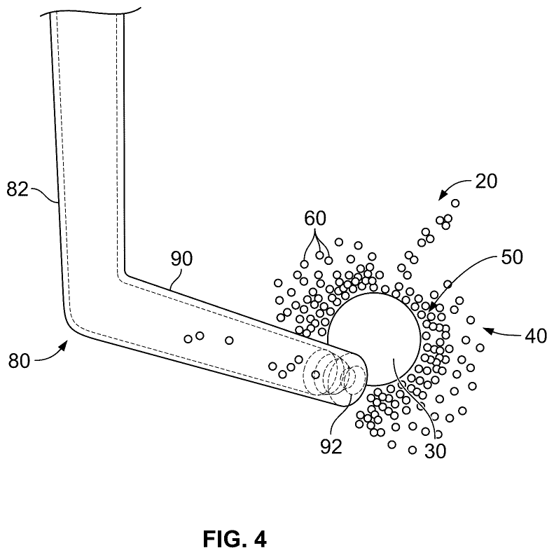

The top perspective view of FIG. 4 better illustrates a positioning of the pipette 80, and specifically of the opening 92 of the distal section 90, relative to the COC 20 for the process of removal of the cumulus cells 40 from the COC 20. In the illustrated example, it is shown that the opening 92 may be positioned slightly to the side, and/or slightly above or below, the COC 20, such as by being laterally offset relative to the COC 20. Such positioning may reduce mechanical stress to the COC 20, as opposed to positioning the opening 92 at a center of the COC 20. It is understood that the opening 92, as well as the distal section 90, may be positioned at any suitable side, angle, and/or height relative to the COC 20, such that the COC 20, and specifically the zone pellucida 34 of the oocyte 30, does not fully close off the opening 92 of the distal section 90 of the pipette 80.

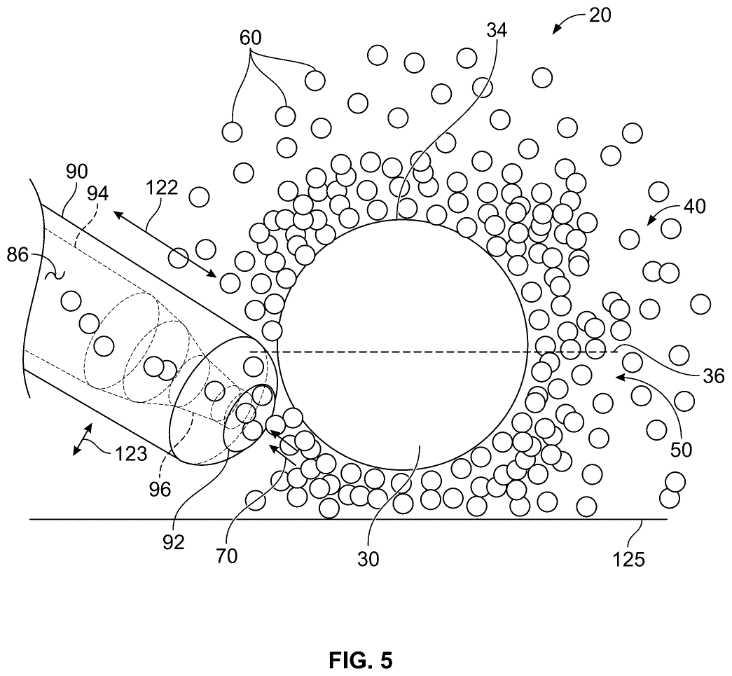

The offset of the opening 92 of the pipette 80 relative to the COC 20 may be better shown in the view of FIG. 5. A horizontal plane 36 passes through a volumetric center of the COC 20, parallel to a horizontal plane 125 on which the COC 20 is supported. The pipette positioning system 130 may be configured to position the opening 92 at the end of the distal section 90 of the pipette 80 at a point that is offset relative to the horizontal plane 36. Specifically, as illustrated, the opening 92 is positioned below the horizontal plane 36 passing through the COC 20. Such positioning of the opening 92 allows cumulus cells 40 to be taken up into the suction channel 86 of the pipette 80 through the opening 92 along the path of the suction 70, without the opening 92 fully confronting the oocyte 30 or the COC 20.

Such positioning of the opening 92 relative to the COC 20 also positions the distal section 90 of the pipette 80 at a non-zero angle with respect to the horizontal plane 125 on which the COC 20 is supported. The angle of the distal section 90 of the pipette 80 relative to the horizontal plane 125 may be any suitable angle less than or equal to 90 degrees. In one example, the non-zero angle of the distal section 90 relative to the horizontal plane 125 may be less than 75 degrees. In a further example, the non-zero angle of the distal section 90 relative to the horizontal plane 125 may be between 10 and 45 degrees.

FIG. 5 also illustrates the direction 122 of the piezo vibration driven by the piezo actuator 120. In the case that the proximal section 82 and the distal section 90 are collinear, the piezo vibration of the distal section 90 would also occur in the direction 122. Alternatively, in the case that the distal section 90 is positioned at a non-zero angle relative to the proximal section 82, the vibration of the distal section 90 may instead be provided in a direction 123 that is non-parallel to the distal section 90. In one example, the direction 123 may be perpendicular to the distal section 90.

It is also contemplated that the piezo vibration driven by the piezo actuator 120 may not be parallel to the pipette holder 110, and may even be perpendicular to the pipette holder 110. Therefore, it will be understood that it is within the scope of the present disclosure that the direction of the piezo vibration driven by the piezo actuator 120 at the pipette 80 may be parallel to at least one of the proximal section 82 and the distal section 90, may be perpendicular to at least one of the proximal section 82 and the distal section 90, or may be provided at an angle that is neither parallel nor perpendicular to at least one of the proximal section 82 and the distal section 90.

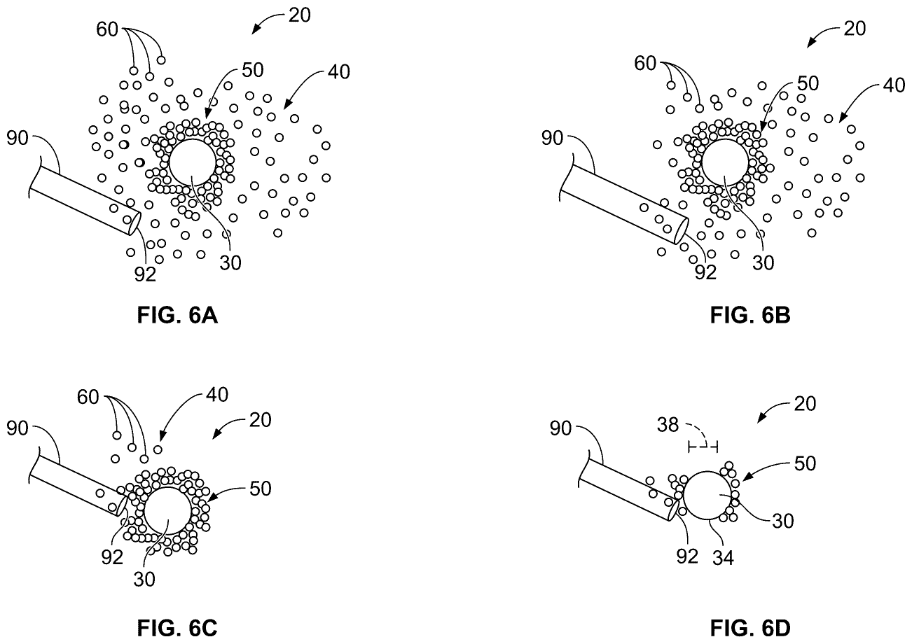

FIG. 6A-6D illustrate plan views of the COC 20 at various points in the process of the removal of the cumulus cells 40 from the COC 20 and during the application of piezo vibration to the pipette 80 by the piezo actuator 120.

FIG. 6A illustrates a mostly intact COC 20 wherein removal of the cumulus cells 40 is commencing with removal of the non-corona cumulus cells 60. The opening 92 of the distal section 90 is positioned adjacent to, but offset from, the COC 20. The opening 92 applies the negative pressure or suction 70 of the suction channel 86, generated by the suction source 114, to the COC 20, as well as applying the piezo vibration generated by the piezo actuator 120 to the COC 20. The suction 70 and the piezo vibration in the direction 122 dislodge and remove cumulus cells 40 from the COC 20. At least some of the cumulus cells 40 that are removed from the COC 20 may be drawn into the suction channel 86. In one example, substantially all of the cumulus cells 40 that are removed from the COC 20 may be drawn into the suction channel 86.

In FIG. 6B, at least some of the non-corona cumulus cells 60 have been removed from the COC 20 and either drawn up into the suction channel 86 or dispersed into the surrounding medium within which the COC 20 is contained. The opening 92 of the distal section 90 is illustrated in the same position as in the view of FIG. 6A. It is understood that the system 100 may be configured to leave the distal section 90 and the opening 92 in a fixed position while the removal of the cumulus cells 40 is being performed, with the suction 70 and the piezo vibration in the direction 122 causing the COC 20 to move relative to the opening 92, while the opening 92 remains in the fixed position.

In FIG. 6C, at least most, if not all of, the non-corona cumulus cells 60 have been removed from the COC 20 and either drawn up into the suction channel 86 or dispersed into the surrounding medium within which the COC 20 is contained, while the majority of the corona cells 50 remain. In the view of FIG. 6C, the opening 92 of the distal section 90 is illustrated in a different position relative to the COC 20 than shown in the view of FIGS. 6A and 6B. It is understood that such variation in position may be due to movement of the opening 92 by the pipette positioning system 130 relative to a fixed position of the COC 20, or may be due to movement of the COC 20 relative to a fixed position of the opening 92, caused by the force of the suction 70 and/or the piezo vibration generated by the piezo actuator 120.

In another example, the illustrated variation in position may be due to a combination of movement of the opening 92 of the pipette 80 and movement of the COC 20. For example, the pipette positioning system 130 may initially be configured to maintain the opening 92 of the pipette 80 in a fixed position, while the COC 20 is moved relative to the fixed position of the opening 92 due to the force of the suction 70 and/or due to the piezo vibration movement generated by the piezo actuator 120. However, if, during the process of the removal of the cumulus cells 40, the vision system 128 determines that the movement of the COC 20 and/or the denudation progress has stalled or slowed, then the pipette positioning system 130 may be configured to be operated to move the position of the opening 92 relative to the COC 20. Such movement of the opening 92 may also still occur while the COC 20 is also moving about the opening 92 due to the suction 70 and piezo vibration forces.

In FIG. 6D, the majority of the corona cells 50 have been removed from the COC 20, exposing at least a portion of the zona pellucida 34 of the oocyte 30. The system 100 and the vision system 128 may be operated and configured to determine when the extent or degree of removal of the cumulus cells 40 satisfies a denudation condition, and then to stop the removal of the cumulus cells 40 when the vision system 128 has determined that the denudation condition has been satisfied.

In one example, the denudation condition is determined to be satisfied when all of the non-corona cumulus cells 60 and at least some of the corona cells 50 have been removed from the COC 20. In another example, the denudation condition is determined to be satisfied when the vision system 128 determines that at least some of the non-corona cumulus cells 60 and at least some of the corona cells 50 have been removed from the COC 20. In another example, the denudation condition is determined to be satisfied when the vision system 128 determines that all of the cumulus cells 40, including all of the non-corona cumulus cells 60 and all of the corona cells 50, have been removed from the COC 20.

In another example, the denudation condition is determined to be satisfied when the removal of the cumulus cells 40 has proceeded for a specified period of time.

In another example, the denudation condition is determined to be satisfied when the vision system 128 determines that a portion of the zona pellucida 34 of the oocyte 30 that has been exposed is sufficient. For example, the system 100 and the vision system 128 may be configured to proceed with removal of ones of the cumulus cells 40 until a contiguous surface area 38 of the zona pellucida 34 of the oocyte 30 larger than a specified size has been exposed. The specified size of the contiguous surface area 38 of the zona pellucida 34 of the oocyte 30 to be exposed is based on a diameter of the opening 92 of the pipette 80, or based on a diameter of an opening of an additional, separate pipette, such as a holding pipette.

In another example, the specified size of the contiguous surface area 38 of the zona pellucida 34 of the oocyte 30 to be exposed may include exposing two opposing contiguous surface areas 38 positioned generally or directly opposite one another about the oocyte 30. The specified size of one of the two contiguous surface areas 38 may be based on a diameter of the opening 92 of the pipette 82 or of an opening of an additional, separate pipette, while the specified size of the other of the two contiguous surface areas 38 may be based on a diameter of an opening of an ICSI needle. In this way, the denudation condition is determined to be satisfied when the two opposing contiguous surface areas 38 of the zona pellucida 34 of the oocyte 30 have been exposed, and the oocyte 30 may then be used in an ICSI procedure where a holding pipette and an ICSI needle may be applied to the opposing two contiguous surface areas 38 of the oocyte 30. In this way, the holding pipette holds the oocyte 30 at one of the contiguous surface areas 38 to support the oocyte 30 while an ICSI needle is inserted through the zona pellucida 34 at the opposing second contiguous surface area 38.

The operation of the system 100 for the removal of cumulus cells 40 from the COC 20 using a combination of force of suction 70 and piezo vibration generated by the piezo actuator 120 coupled to the pipette 80 may provide many advantages over traditional processes for the removal of cumulus cells 40 from COCs 20. For example, the use of the piezo vibration to loosen and dislodge cumulus cells 40 from the COC 20 may be gentler on the COC 20 and result in less stress on the oocyte 30 than traditional methods that require or result in the application of suction force directly to the zona pellucida 34 of the oocyte 30, thus resulting in more favorable outcomes from ICSI procedures. In another example, the use of the piezo vibration operation of the system 100 may eliminate the need to use hyaluronidase in the process of removal of the cumulus cells 40. Without the presence of hyaluronidase, the denuded oocyte 30 may not need to be moved to a different location or to a different culture medium droplet for the ICSI procedure, simplifying the denudation and ICSI processes.

### Clauses

Various example embodiments of the invention are described in the following clauses.
Clause 1: A system for removal of surrounding cells from a biological sample, the system comprising: a pipette including (i) a proximal section and (ii) a distal section with an opening configured to contact the biological sample, wherein a suction channel, ending at the opening, is defined through the proximal and distal sections; a suction source fluidly coupled with the pipette and configured to create a negative pressure within the suction channel; and a piezo actuator mechanically coupled with the pipette and configured to drive piezo vibration of the pipette to remove ones of the surrounding cells.
Clause 2: The system of clause 1 further comprising a pipette positioning system configured to position an end of the distal section of the pipette at a point that is offset relative to a horizontal plane passing through a volumetric center of the biological sample.
Clause 3: The system of clause 2 wherein the pipette positioning system is configured to position the opening below the horizontal plane passing through the volumetric center of the biological sample.
Clause 4: The system of clause 2 or clause 3 wherein the pipette positioning system includes a robotic pipetting arm.
Clause 5: The system of any of clauses 2 through 4 wherein the pipette positioning system is configured to position the distal section of the pipette at a non-zero angle with respect to a horizontal plane on which the biological sample is supported.
Clause 6: The system of clause 5 wherein the pipette positioning system is configured to position the distal section of the pipette at an angle of 10-45 degrees relative to the horizontal plane.
Clause 7: The system of any of clauses 1 through 6 wherein the proximal section and the distal section of the pipette are collinear.
Clause 8: The system of any of clauses 1 through 7 wherein the distal section is positioned at a non-zero angle with respect to the proximal section.
Clause 9: The system of any of clauses 1 through 8 wherein a direction of the piezo vibration of the pipette is parallel to at least one of the proximal section and the distal section.
Clause 10: The system of any of clauses 1 through 9 wherein a direction of the piezo vibration of the pipette is perpendicular to at least one of the proximal section and the distal section.
Clause 11: The system of any of clauses 1 through 10 further comprising a pipette holder configured to carry the pipette.
Clause 12: The system of clause 11 wherein the piezo actuator is mechanically coupled with the pipette via the pipette holder.
Clause 13: The system of clause 11 or clause 12 further comprising a robotic pipetting arm configured to carry the pipette holder.
Clause 14: The system of any of clauses 1 through 13 wherein the pipette is a glass capillary pipette.
Clause 15: The system of any of clauses 1 through 14 wherein the pipette is a large-bore pipette with the suction channel extending through a bore and ending at the opening.
Clause 16: The system of clause 15 wherein a diameter of the bore is larger than a diameter of the opening.
Clause 17: The system of any of clauses 1 through 16 wherein the opening applies the negative pressure of the suction channel to the biological sample.
Clause 18: The system of any of clauses 1 through 17 further comprising a vision system configured to determine when the removal of the surrounding cells satisfies a denudation condition.
Clause 19: The system of clause 18 wherein the removal of the surrounding cells is stopped when the vision system determines that the denudation condition has been satisfied.
Clause 20: The system of clause 18 or clause 19 wherein: the biological sample is a cumulus-oocyte complex (COC); and the surrounding cells are cumulus cells of the COC.
Clause 21: The system of clause 20 wherein: the cumulus cells include corona cells and non-corona cumulus cells; and the system is configured to remove all of the non-corona cumulus cells and at least some of the corona cells.
Clause 22: The system of clause 21 wherein the denudation condition is satisfied when the vision system determines that at least some of the non-corona cumulus cells and at least some of the corona cells have been removed from the COC.
Clause 23: The system of any of clauses 18 through 21 wherein the denudation condition is satisfied when the vision system determines that all of the surrounding cells have been removed.
Clause 24: The system of any of clauses 18 through 21 wherein the denudation condition is satisfied when the removal of the surrounding cells proceeds for a specified period of time.
Clause 25: The system of any of clauses 1 through 24 wherein the system is configured to remove ones of the surrounding cells until a contiguous surface area of the biological sample larger than a specified size is exposed.
Clause 26: The system of clause 25 wherein the specified size is based on a diameter of an opening of a pipette.
Clause 27: The system of any of clauses 1 through 26 wherein at least some of the surrounding cells that are removed from the biological sample are drawn into the suction channel.
Clause 28: The system of clause 27 wherein substantially all of the surrounding cells that are removed from the biological sample are drawn into the suction channel.
Clause 29: The system of any of clauses 1 through 28 wherein the system is configured to leave the pipette in a fixed position while the removing is being performed.

### Conclusion

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Unless indicated otherwise, numbering or other labeling of instructions or method steps is done for convenient reference, not to indicate a fixed order. Numerical terms, such as “first,” “second,” and “third,” may be used in the disclosure and claims as unique labels: they are not used to imply a sequence or order unless the context clear indicates otherwise. In other words, a “second element” could be relabeled as a “first element” without departing from the principles of the present disclosure. Further, the presence of a “second element” does not imply or require the presence of a “first element.”

Unless the context clearly indicates otherwise, the singular articles “a,” “an,” and “the” before a noun do not restrict the noun to a single instance. The verbs “comprise,” “include,” and “have” are inclusive and therefore specify the presence of elements without excluding the presence of one or more additional elements.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements are described using various terms, including “connected,” “coupled,” “engaged,” “adjacent,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements.

The term “set” generally means a grouping of one or more elements. The elements of a set do not necessarily need to have any characteristics in common or otherwise belong together. However, in various implementations a “set” may, in certain circumstances, be the empty set (in other words, the set has zero elements in those circumstances). As an example, a set of search results resulting from a query may, depending on the query, be the empty set. In contexts where it is not otherwise clear, the term “non-empty set” can be used to explicitly denote exclusion of the empty set—that is, a non-empty set will always have one or more elements.

A “subset” of a first set generally includes some of the elements of the first set. In various implementations, a subset of the first set is not necessarily a proper subset: in certain circumstances, the subset may be coextensive with (equal to) the first set (in other words, the subset may include the same elements as the first set). In contexts where it is not otherwise clear, the term “proper subset” can be used to explicitly denote that a subset of the first set must exclude at least one of the elements of the first set. Further, in various implementations, the term “subset” does not necessarily exclude the empty set. As an example, consider a set of candidates that was selected based on first criteria and a subset of the set of candidates that was selected based on second criteria; if no elements of the set of candidates met the second criteria, the subset may be the empty set. In contexts where it is not otherwise clear, the term “non-empty subset” can be used to explicitly denote exclusion of the empty set.

The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR. The phrase “A, B, and/or C” should be construed in the same way as the phrase “at least one of A, B, and C.”

1. A system for removal of surrounding cells from a biological sample, the system comprising:
a pipette including (i) a proximal section and (ii) a distal section with an opening configured to contact the biological sample, wherein a suction channel, ending at the opening, is defined through the proximal and distal sections;
a suction source fluidly coupled with the pipette and configured to create a negative pressure within the suction channel; and
a piezo actuator mechanically coupled with the pipette and configured to drive piezo vibration of the pipette to remove ones of the surrounding cells.

2. The system of claim 1 further comprising a pipette positioning system configured to position an end of the distal section of the pipette at a point that is offset relative to a horizontal plane passing through a volumetric center of the biological sample.

3. The system of claim 2 wherein the pipette positioning system is configured to position the opening below the horizontal plane passing through the volumetric center of the biological sample.

4. The system of claim 2 wherein the pipette positioning system includes a robotic pipetting arm.

5. The system of claim 3 wherein the pipette positioning system is configured to position the distal section of the pipette at a non-zero angle with respect to a horizontal plane on which the biological sample is supported.

6. The system of claim 1 wherein the proximal section and the distal section of the pipette are collinear.

7. The system of claim 1 wherein the distal section is positioned at a non-zero angle with respect to the proximal section.

8. The system of claim 1 further comprising:
a pipette holder configured to carry the pipette; and
a robotic pipetting arm configured to carry the pipette holder,
wherein the piezo actuator is mechanically coupled with the pipette via the pipette holder.

9. The system of claim 1 wherein:
the pipette is a glass capillary pipette;
the pipette is a large-bore pipette with the suction channel extending through a bore and ending at the opening; and
a diameter of the bore is larger than a diameter of the opening.

10. The system of claim 1 wherein the opening applies the negative pressure of the suction channel to the biological sample.

11. The system of claim 1 further comprising:
a vision system configured to determine when the removal of the surrounding cells satisfies a denudation condition,
wherein the removal of the surrounding cells is stopped in response to the vision system determining that the denudation condition has been satisfied.

12. The system of claim 11 wherein:
the biological sample is a cumulus-oocyte complex (COC);
the surrounding cells are cumulus cells of the COC;
the cumulus cells include corona cells and non-corona cumulus cells; and
the system is configured to remove all of the non-corona cumulus cells and at least some of the corona cells.

13. The system of claim 12 wherein the denudation condition is satisfied by at least one of:
the vision system determining that at least some of the non-corona cumulus cells and at least some of the corona cells have been removed from the COC;
the vision system determining that all of the surrounding cells have been removed; and
the removal of the surrounding cells having proceeded for a specified period of time.

14. The system of claim 1 wherein the system is configured to remove ones of the surrounding cells until a contiguous surface area of the biological sample larger than a specified size is exposed.

15. The system of claim 14 wherein the specified size is based on a diameter of an opening of a pipette.

16. The system of claim 1 wherein substantially all of the surrounding cells that are removed from the biological sample are drawn into the suction channel.

17. The system of claim 1 wherein the system is configured to leave the pipette in a fixed position while the removing is being performed.
